(19) United States
(12) Patent Application Publication
(10) Pub. No.: US 2017/0124187 A1
(43) Pub. Date: May 4, 2017

(54) METHOD OF ADAPTATION OF A REPRESENTATION OF MUSICAL CONTENT

(71) Applicant: RENAULT s.a.s., Boulogne Billancourt (FR)

(72) Inventors: Jean-Philippe ALEXANDER, La Riche (FR); Frederic SAUNEUF, Velizy Villacoublay (FR)

(73) Assignee: RENAULT s.a.s., Boulogne Billancourt (FR)

(21) Appl. No.: 15/304,441

(22) PCT Filed: Apr. 9, 2015
(86) PCT No.: PCT/FR2015/050950

§ 371 Date: Dec. 21, 2016

(30) Foreign Application Priority Data
Apr. 17, 2014 (FR) 1453481

(51) Int. Cl. G06F 17/30; G11B 27/10

(52) U.S. Cl. CPC G06F 17/30743; G06F 17/30758; G06F 17/30772; G06F 17/30752; G11B 27/105

(57) ABSTRACT

A method adapts a representation of musical contents. The method includes generating a musical content representation centered on a first musical content and playing the musical content on which the representation is centered. The musical content on which the representation is centered is played so long as no action is undertaken by the user. The method also includes playing a new track when an action ending the play of the musical content is undertaken by the user, continuing the play of the musical content when an action not ending the play of the musical content is undertaken and the action is taken into account, playing new musical content when the play of the musical content on which the representation is centered is finished, and modifying the representation with each new play of a musical content so as to be centered on the new musical content played.

The invention relates to the adaptation of a representation of musical content, in this case audio files, depending on the wishes of a user, and more specifically the modification of a representation of musical contents depending on the indications of a user on the track being listened to.

A representation of music tracks corresponds to the organization of a plurality of musical contents stored in a database. The representation can relate to all of the content of the database or only some of the music tracks the database.

Generally, a representation of musical contents is in the form of a tree structure organized from the genres, then from the artists, then from the albums, then from the tracks making up an album.

When the representation includes a large number of musical contents, many handling operations are often necessary to access a music track. Furthermore, when the user does not have an exact idea of the track that the latter wishes to listen to, going through the complete tree structure can be long and boring. For example, a database can comprise more than 500 artists, more than 10 albums per artist which represents more than 5000 albums, etc.

This organization furthermore gives rise to a problem. detrimental to safety when the database from which the representation is generated is on-board a moving motor vehicle.

Indeed, when the user drives the motor vehicle, the risks of an accident are increased once the user cannot keep the entire attention thereof on the road. The music data classification. presentation modes are therefore not optimized for driving use.

The greater the number of handling operations of an interface, the greater are the risks of accidents. This is the case regardless of the type of direct or indirect touch interface used.

A direct interaction surface can be a surface such as a touch screen or any other type of interactive display surface. An indirect interaction surface can be a touchpad tactile remote control.

In a case where the user knows exactly the desired track, it is possible for the latter to use a voice command to directly state the request thereof, for example by saying the name of the music track. This is the best of the cases of use, from a safety perspective.

However, in a case where the user does not specifically know the track sought thereby, the latter will not use the voice recognition or even a virtual keyboard in order to type in or indicate directly what the latter wishes to listen to. In this case, two solutions are generally proposed by the interfaces: the random play of the music tracks of the database or the browsing of the tree structure the man machine interface, also noted MMI, for the music portion.

In the case of the random play, the probability of the user liking all of the music propositions made by the system is low. The user will then be forced to repeatedly move to the following track.

In the case where the user decides to browse through the tree structure, the task is then long, boring and dangerous when the user is a motor vehicle driver.

The first aim of the invention is to optimize the search for a musical content when the user does not know exactly the desired track to listen to, by taking into account the comments thereof with regard to the desires thereof at that moment. Instead of a classification by musical genre which complicates a classification of very different music tracks, the aim of the invention is to organize a search according to the expected qualities of the musical contents or the sensibilities of the user, such as for example energizing or relaxing, or somber or positive, etc.

Solutions exist to classify the music tracks in a so-called “music cloud” representation mode wherein the music tracks are arranged along two precise axes.

However, these axes generally do not correspond. to the desires of the user but to a musical genre. Other parameters can also be used such as the release date of the albums, the names of the artists in alphabetical order, the listening frequency, etc. Axes of this type do not offer the user an effective search solution. Such axes can even give rise to different interpretations, like the musical genre, the interpretation of which can be subjective.

Furthermore, the music is generally classified by a panel of experts who listen to the music. This methodology is subjective, fallible and long. It does not allow the music tracks to be qualified quickly so that they can be positioned in the music cloud. Moreover, if an expert is replaced, the new qualification will not be that which would have been produced by the old expert.

Systems also exist which simply ask the user to declare preferences, and moods. However, the methods implemented by such systems are fallible since, firstly, the preferences can vary over time, whether this be during the day, during the week or during an even. wider time frame of reference and, secondly, it is not possible to deduce musical tastes from a mood.

A second aim of the invention is, therefore, to overcome the disadvantages stated above by proposing an automated method allowing a music cloud to be generated quickly from a music database, without the intervention of experts.

Another aim of the invention is to provide a system for managing the man-machine interaction via a touch screen offering a quicker music experience automatically creating playlists in a music cloud, and therefore allowing a more safe interface for use on-board a motor vehicle.

According to one aspect of the invention, the adaptation of a representation of musical contents is proposed, which comprises the generation of the musical content representation centered on a first musical content, and playing of the musical content on which the representation is centered.

According to a feature of the invention, the musical content on which the representation is centered is played so long as no action is undertaken by the user, and the method comprises the following steps:
if an action ending the play of the musical content is undertaken by the user, a new musical content is played,
if an action not ending the current track play is undertaken, the action is taken into account, and the play of the musical content continues, if the play of the musical content on which the representation is centered. is finished, a new musical content of the representation is played,
said representation being modified with each new play of a musical content so as to be centered on the new musical content played.

The method therefore offers an enriching music experience by helping with the creation of a self-adapting musical discovery journey requiring the minimum of handling by the user.

The invention therefore allows choices and declarations of the user to be taken. into account in order to refine the knowledge of the system with respect to the user.

The method further allows for modifying the representation of the musical contents right from the first action of the user. If the user does not undertake any action, the sequence of the music tracks of the representation, also called the music cloud, is determined randomly from the music cloud tracks which have not yet been played, the next track being randomly determined at the end of each track play.

Each action of the user, whether it ends, or not, the play of the musical content, i.e. of the music track being played, brings about a modification of the representation of the musical contents. These modifications allow the sequence of the musical contents to be adapted such as to adapt in real time to the wishes of the user. The choice of the tracks is then semi-random given that it is from a limited group of musical contents by taking into account parameters defined by the actions of the user which express the wishes thereof.

Therefore, the representation as has been created. and the means of interaction, i.e. of adaptation, allow the user to not go through a tree structure in order to listen to and discover musical contents, or music tracks. In one selection action, the user can listen to music, and in another action, the user can indicate the liking, or not, thereof of the musical content being listened to and influence the next musical contents to be listened to without however explicitly naming the next track.

The reduction in the number of interactions between the user and the system implementing the method allows the safety to be increased in uses on-board a motor vehicle.

Preferably, the generation of the representation of the musical contents comprises the generation of the acoustic components of each musical content, or music track, contained in a music database, the calculation of the acoustic proximity of each musical content, and the generation of the representation organized along two dimensions of the musical content of the database.

The generation of such a representation, also called the “music cloud”, allows the obtained. representation to be optimized. The music data is therefore classified in a two-dimensional space, the axes of which do not have a fixed meaning, but a meaning that varies according to the user. The axes can, for example, be linked to the frequency of the voice component, to the number of beats per minute, to the frequency richness, to the type of instrumentation, or to the variations in sound level.

The music cloud is generated by analyzing the sound signal of each musical content of the music database. The analysis can be carried out in real-time or in hidden time. If the analysis is carried out in real-time, the cloud chances in the form. thereof as the user adds tracks. If it is carried out in hidden time, it is carried out as a background task, while the user listens to the music but does not see the cloud which will be updated at the next display after addition of tracks. The analysis of the features of the sound signal of each musical content allows the distance to be determined which separates each musical content along two axes. These axes are automatically generated by a principal component analysis. Thus, the closer a musical content is to another, the more it will appear similar to the ear of the user. Therefore, if the user likes the musical content that is being listened to, the latter knows that the musical contents which are analytically close will be pleasing thereto.

Preferably, the music cloud generated at the start of the adaptation method comprises all of the musical contents of the database and is centered on the last musical content listened to by the user.

The user can advantageously choose an action not ending the current track play from the indication that the latter likes the musical content being played, and the request to subsequently have musical contents similar to the track being played.

The actions which do not end the play of the musical content allow the user to give a positive indication on the type of musical content that the latter wishes to listen to next while continuing the current musical content play.

Such a positive indication causes the generation of a play area to be favored comprising the musical content being played and similar musical contents.

Such an indication therefore allows an increase in the number of similar musical contents in the next musical contents to come, i.e. an increase in the frequency with which similar musical contents are played. This is achieved while avoiding selection of a musical content similar to the track being played as the next musical content to be played just after the musical content being played for which the user has indicated a liking for this musical content.

The next musical content played will therefore be chosen in a semi-random manner from a group of musical contents comprising all of the other musical contents with the exception of the musical content being played and of the similar musical contents, of the musical contents previously played, and possibly with the exception of the musical contents included in the music play area to be avoided.

The choice is semi-random in that the musical contents have already been limited using the indications of the user.

The request to subsequently have musical contents similar to the musical content being played causes the generation of a playlist with only musical contents similar to the musical content being played, the play representation being modified in order to only comprise the musical contents of the generated playlist.

This request allows the user to request that the next musical contents played are musical contents similar to the musical content being played. Such a request allows the random or semi-random route process to be exited by generating a playlist comprising a limited number of similar musical contents.

The method can further comprise a step of storing the playlist generated in this manner, the storage being carried out in response to a user request.

The list can be modified according to the actions undertaken by the user as the latter listens to the musical contents of the list.

A playlist can also be created from a selection by the user of a set of musical contents, the set being selected by an action of the user on a touch screen, wherein the action can be the plotting of a closed area, such as a circle, on the touch screen to define the musical contents to be selected, or the selection of musical contents using a path plotted between the musical contents and indicated on the screen.

Preferably, the first musical content to be listened to from the representation corresponds to the last musical content listened to, or is chosen from the last musical contents added to the database from which the representation is generated, or is chosen from the musical contents of a play area to be favored.

Advantageously, the user can choose an action ending the current musical content play from the request for the previous musical content, the request for the following musical content, the indication that the user does not like the musical content being played, and/or the manual selection of a new musical content.

Preferably, the indication by the user of not liking the musical content being played leads to generating a music play area to be avoided. comprising the musical content being played and similar musical contents, stopping the current play, selecting a new musical content from the musical contents contained. in the representation and excluded from the music play area to be avoided and playing the new musical content selected.

The music play area to be avoided comprises the musical content indicated and the similar musical contents. The musical contents included in the music play area to be avoided will be marked as musical contents to not be selected, therefore reducing the number of musical contents that can be selected.

The indications that the user likes or does not like a musical content are stored in a memory and counted with each indication. This counting of the indications allows for reducing the probability that a musical content is played particularly if, on each occasion, an indication is given showing the user does not like the musical content, or conversely for increasing the probability that it is played particularly if, on each occasion, an indication is given showing the user likes the musical content.

According to another aspect, a computer system is proposed which comprises means configured to implement the method as defined above.

According to yet another aspect, a computer program product is proposed which can be loaded directly into a memory of a computer system, comprising portions of software code for executing the method as defined above when said program is executed by said computer system.

According to yet another aspect, a medium is proposed that can be read by a computer system having instructions which can be executed. by computer, which instructions are suitable for causing the computer system to execute the method as defined above.

Other advantages and features of the invention will emerge upon examining the detailed description of a method of implementing the invention, which is in no way limiting, and the appended drawings, wherein:

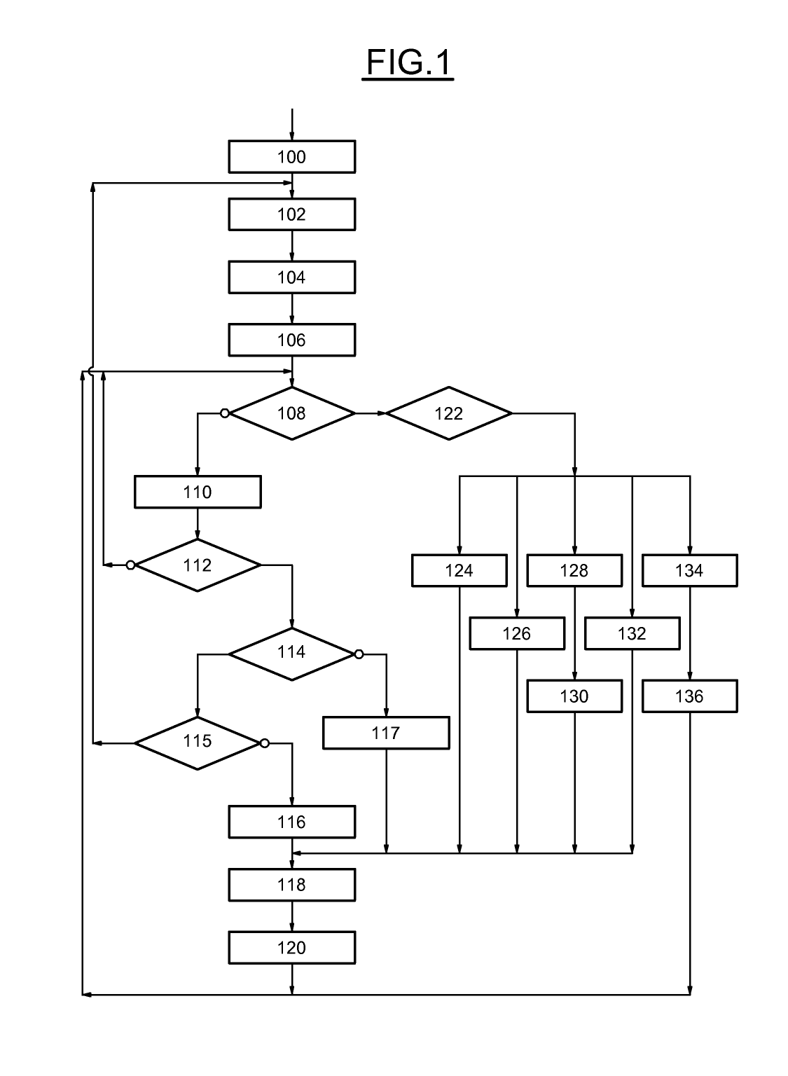

FIG. 1 shows a flow diagram of a method of adaptation of a representation of a group of music tracks according to a method of implementing the invention;

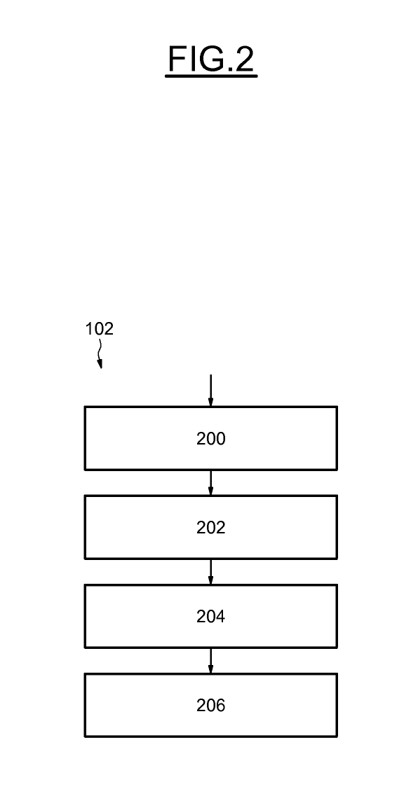

FIG. 2 shows a flow diagram of a method of generating the representation of a group of music tracks implemented in the method illustrated in FIG. 1.

FIG. 1 schematically illustrates a flow diagram of a method of adaptation of a representation of a musical content according to a method of implementing the invention.

Musical content means in particular a set of audio files which are coded for example, corresponding to these music tracks.

In a first step 100, the adaptation method is launched by selecting a command requesting the launching of a music cloud.

In a following step 102, a music cloud comprising a number K of music tracks coming from a music database is generated from a method of generating the representation of a group of music tracks as shown in FIG. 2.

As illustrated in FIG. 2, the step 102 comprises, in a first step 200, the loading of the K tracks of a music database, and in a second step 202, the generation of the acoustic components of each of the K tracks loaded, then, in a third step 204, calculating the acoustic proximity of each loaded track, and finally, in a fourth step 206, the generation of the representation in a music cloud, which is organized along two dimensions of the music tracks.

The analysis of the acoustic components of the sound signal of each track allows the distance which separates each track along two axes to be determined. These axes are automatically generated by a principal component analysis.

The principal component analysis, noted as PCA, is a method of analyzing data of the division of multivariate statistics, consisting in transforming variables that are correlated with each other into new variables that are uncorrelated from each other. These new variables are called “principal components”, or principal axes. Generally, it allows the number of variables to be reduced and the information to be made less redundant.

It is an approach that is both geometric, the variables being represented in a new space in maximum inertia directions, and statistical, the search relating to independent axes best explaining the variability of the data

As illustrated in FIG. 1, in a following step 104 of the adaptation method, the music cloud of K tracks is modified in order to be centered on the last music track of the track group listened to by the user.

As an alternative, the music cloud could be centered on a track chosen from the last tracks added to the music database, or on a track chosen from the play area to be favored.

In a following step 106, the music track on which the music cloud is centered is played such that the user can listen thereto.

In a following step 108, a test checks if an action has been undertaken by the user.

If no action is undertaken, the music track continues to play without interruption (step 110). The steps 108 and 110 are repeated so long as no action is undertaken by the user, and so long as the play of the music track is not finished.

If no action has been undertaken by the user and it is detected. in a step 112 that the play of the track is finished, it is then checked during a step 114 if a specific playlist to which the current track belongs has been selected. The playlist comprises a number less than K music tracks.

If a playlist has been initially selected, it is checked, in a step 115, if the playlist is finished. If it is finished, the process returns to the step 102 centering the music cloud of K musical content on the last music track played.

However, if the music track, the play of which has just ended, is not the last on the playlist, the following track of the playlist is selected in a step 116, and the track selected in this manner is played in a step 118.

The music cloud is then modified, in a step 120, such that it is centered on the new track being played. The method then resumes at the step 108.

If a playlist has not been selected, a new track is selected in a step 117. Selection is carried out in a semi-random manner using the music cloud tracks that have not been played.

If an action. of the user is detected during the step 108, it is determined in a step 122 which action has been undertaken by the user.

If the detected action corresponds to a request for the previous track, in a step 124, the current play is interrupted and the track previously listened to by the user is selected. The method then moves to the step 118 in which the selected track is played, and to the step 120 in which the music cloud is re-centered on the track being played.

If the detected action corresponds to a request for the following track, in a step 126, the current play is interrupted and another music track is chosen in a semi-random manner. The selection is carried out in a semi-random manner since it is undertaken from all of the music tracks of the cloud, but with the condition that the new track is distant, in terms of principal components, from the track that has just been interrupted whether it is outside a play area to be avoided, and whether it is preferably in a play area to be favored. The method then moves to the step 118 in which the selected track is played, and to the step 120 in which the music cloud is re-centered on the track being played.

If the detected action corresponds to an indication showing the user does not like the music track being played, in a step 128, a music play area to be avoided is generated. The music play area to be avoided comprises the audio file being played and similar tracks, i.e. the closest tracks according to the principal component analysis. The closest tracks will be defined, for example, as the tracks having less than 5% difference with respect to one or more principal components of the PCA analysis. Other definitions can also be envisaged. In a following step 130, the current audio file play is interrupted and a new file is selected from the musical contents of the music cloud. which are excluded from the music play area to be avoided. The method then passes to the step 118 in which the selected track is played, and to the step 120 in which the music cloud is re-centered on the track being played.

If a music play area already exists, the step 128 comprises the addition of the track being played and of the similar tracks to the music play area to be avoided.

If the detected action corresponds to an indication that the user likes the music rack being played, in a step 132, a music play area to be favored is generated. The music play area to be favored comprises the track being played and similar tracks. The current track play continues, and the method returns to the step 108 in order to detect other possible actions undertaken by the user or to detect the end of the current track at the step 112 if no other action is undertaken.

If the detected action corresponds to a request to subsequently have tracks that are similar to the track being played, in a step 134, a specific playlist is generated. The specific playlist comprises the track being played and tracks similar to the track being played. In a following step 136, the music cloud is modified to correspond to the specific playlist generated in this manner. The current track play continues, and the method returns to the step 108 in order to detect other possible actions undertaken by the user or to detect the end of the current track at the step 112 if no other action is undertaken.

Such a method can be implemented by an electronic system or software means. The system or the means implementing this method can be installed on-board a motor vehicle.

The invention therefore provides an automated method, and a system of interaction with a user implementing the method, for generating quickly and in an automated manner a music cloud from a music database and for creating and adapting playlists in the music cloud from the wishes of the user while minimizing the handling operations of the user. The reduction in the number of handling operations therefore allows a safer interface to be created in particular for a use on-board a motor vehicle.

Furthermore, the method implemented is the most sustainable possible by taking into account the choices and the declarations of the user in order to refine the knowledge of the system in relation to the user.

1. method of adaptation of a representation of musical contents, comprising:
generating a musical content representation centered on a first musical content and playing of the musical content on which the representation is centered, the musical content on which the representation is centered being played so long as no action is undertaken by the user;
playing a new track when an action ending the play of the musical content is undertaken by the user;
continuing the play of the musical content when an action not ending the play of the musical content is undertaken and the action is taken into account;
playing new musical content when the play of the musical content on which the representation is centered is finished; and
modifying said representation with each new play of a musical content so as to be centered on the new musical content played.

12. The method as claimed in claim 11, wherein the generation of the representation of the musical contents comprises generation of acoustic components of each musical content contained in a music database, calculation of an acoustic proximity of each musical content, and generation of the representation organized along two dimensions of the musical contents contained in the database.

13. The method as claimed in claim 11, wherein the user can choose an action not ending the current musical content play from an indication that the user likes the musical content being played and a request to subsequently have musical contents similar to the musical content being played.

14. The method as claimed in claim 13, wherein the indication by the user of liking the musical content being played leads to generating a play area to be favored comprising the musical content being played and similar musical contents.

15. The method as claimed in claim 13, wherein the request to subsequent, have musical contents similar to the track being played leads to generating a playlist with only musical contents similar to the musical content being played, the play representation being modified in order to only comprise the musical contents of the generated playlist.

16. The method as claimed in claim 11, wherein a first track to be listened to from the representation of the musical contents corresponds to a last musical content listened to, or is chosen from last musical contents added to the database from which the representation is generated, or is chosen from musical contents of a play area to be favored.

17. The method as claimed in claim 11, wherein a user can choose an action ending the current musical content play from at least one of an indication that the user does not like the musical content being played, a request for the previous musical content, a request for following musical content, and a manual selection of a new musical content.

18. The method as claimed in claim 17, wherein the indication by the user of not liking the musical content being played leads to generating a music play area to be avoided comprising the musical content being played and similar musical contents, stopping the current play, selecting a new musical content from the musical contents contained in the representation and excluded from the music play area to be avoided, and playing the new musical content selected.

19. A computer system, comprising:
means for generating a musical content representation centered on a first musical content and playing of the musical content on which the representation is centered, the musical content on which the representation is centered being played so long as no action is undertaken by the user;
means for playing a new track when an action ending the play of the musical content is undertaken by the user;
means for continuing the play of the musical content when an action not ending the play of the musical content is undertaken and the action is taken into account;
means for playing new musical content when the play of the musical content on which the representation is centered is finished; and
means for modifying said representation with each new play of a musical content so as to be centered on the new musical content played.

20. A non-transitory computer readable medium storing a medical it age processing program that, when executed by a computer, causes the computer to execute the method as claimed in claim 11.
